(19) United States
(12) Patent Application Publication
(10) Pub. No.: US 2026/0309128 A1
(43) Pub. Date: Oct. 8, 2026

(54) BLADE GUIDING APPARATUS

(71) Applicant: Vestas Wind Systems A/S, Aarhus N. (DK)

(72) Inventors: Martin Werner Nielsen, Svenstrup J (DK); Kennet Hvid Nielsen, Randers NV (DK)

(73) Assignee: Vestas Wind Systems A/S, Aarhus N. (DK)

(21) Appl. No.: 19/482,064

(22) PCT Filed: Apr. 30, 2024
(86) PCT No.: PCT/DK2024/050096

§ 371 Date: Nov. 6, 2025

(30) Foreign Application Priority Data
May 10, 2023 (DK) PA202370228

(51) Int. Cl. F03D 13/10; F03D 1/06

(52) U.S. Cl. CPC F03D 13/108; F03D 1/06; F05B 2230/604

(57) ABSTRACT

The present disclosure relates to a blade guiding apparatus for facilitating connection between a wind turbine blade and a rotor hub. The blade guiding apparatus has at least one pin which is associated with one of a wind turbine blade or a rotor hub and a frame having a hole for receiving the pin, said frame being associated with the other of the wind turbine blade or the rotor hub. The blade guiding apparatus also features an inflatable part which is configured to, upon inflation, expand from an uninflated condition, in which relative movement between the pin and the frame is not impeded, to an inflated condition, in which the pin is secured within to the frame.

### FIELD OF THE INVENTION

The present invention relates to a blade guiding apparatus for facilitating connection between a wind turbine blade and a rotor hub, a wind turbine comprising said blade guiding apparatus and a method of using the same.

### BACKGROUND OF THE INVENTION

In modern wind turbines, the wind turbine blades are typically mounted to the rotor hub via a series of bolts which are provided at the root end of the turbine blade and become located within corresponding boltholes provided at the rotor hub (or vice versa). A single blade may feature as many as fifty or more bolts to facilitate connection between the blade root and the rotor hub and so, due to the size and weight of modern wind turbine blades, manoeuvring the blades so that each bolt is correctly aligned with its corresponding bolthole is extremely difficult.

One way in which this problem can be addressed is by providing one or more guide rods at the rotor hub which are configured to engage with a corresponding slot provided at the root end of the blade to help in bringing the two components into alignment.

However, since the rotor hub is typically installed atop the tower section when the turbine blades are attached, the wind turbine (and the blades to be attached to the wind turbine) can be exposed to high winds which can cause the rotor hub and blades to move relative to one another. Furthermore, when the wind turbine is installed in an offshore location, waves and/or other tidal motions can also act on the wind turbine which further increases the amount of relative movement between the blades and the rotor hub. As such, even with guide rods, the process of connecting one or more turbines blades to a rotor hub is an extremely challenging and potentially dangerous process.

It is therefore an aim of the present disclosure to provide a means for more easily facilitating a connection between a wind turbine blade and a rotor hub.

### SUMMARY OF THE INVENTION

A first aspect of the present disclosure provides a blade guiding apparatus for facilitating connection between a wind turbine blade and a rotor hub, the blade guiding apparatus comprising:
a pin;
a frame comprising a hole for receiving the pin; and
an inflatable part configured to, upon inflation, expand from an uninflated condition in which relative movement between the pin and the frame is not impeded by the inflatable part, to an inflated condition in which said relative movement is impeded by the inflatable part.

Advantageously, upon inflation, the inflatable part of the blade guiding apparatus provides a secure connection between the pin and the frame thereby synchronizing the movement of the pin and the frame (and hence the components to which they are mounted). In this way, relative movement between the components on which the pin and frame are mounted (e.g., the rotor hub and the wind turbine blade) can be reduced thereby making it much easier for an operator to connect them.

In some examples, the frame may form part of the structure of the blade.

In some examples, the frame may be provided as a separate component (e.g., a post-installed tool).

In some examples, the inflatable part may be configured to, upon inflation, form an interference fit between the pin and the frame.

In some examples, the inflatable part may contact only one of the pin or the frame when is in its uninflated condition, and the inflatable part may contact both the pin and the frame when it is in its inflated condition.

In some examples, the inflatable part may come into contact with the pin or the frame as it expands to its inflated condition.

In some examples, the inflatable part may be carried by the pin.

In some examples, the blade guiding apparatus may further comprise a pumping arrangement in fluid communication with the inflatable part for actuating the inflatable part between the uninflated and inflated conditions.

In some examples, the pumping arrangement may be housed inside the pin.

In some examples, the pumping arrangement may be located remotely.

In some examples, the pumping arrangement may be housed in the rotor hub.

In some examples, the inflatable part may be carried by the frame.

In some examples, the inflatable part may be provided in the hole.

In some examples, the inflatable part may extend around a circumference of the pin.

In some examples, the inflatable part may extend around a circumference of the hole.

In some examples, the inflatable part may be substantially torus-shaped (i.e., doughnut-shaped).

In some examples, the inflatable part may comprise a plurality of inflatable cushions (i.e., sausages).

In some examples, the blade guiding apparatus may comprise a first pin and a second pin.

In some examples, the blade guiding apparatus may further comprise an interconnection provided between the first pin and the second pin.

In some examples, the pin may comprise a fibre-reinforced composite material.

In some examples, the pin may comprise a carbon-fibre reinforced composite material.

In some examples, the blade guiding apparatus may further comprise a funnel provided in the hole,

In some examples, the funnel may comprise a reinforcing material (e.g., steel or aluminium).

In some examples, the frame may comprise at least one piston for urging against an internal surface of a wind turbine blade.

In some examples, the frame may comprise a pair of opposing pistons for urging against an internal surface of a wind turbine blade.

In some examples, the pin may be formed from a plurality of releasably connectable sections.

In some examples, the weight of each section may be less than 20 kg.

In some examples, the blade guiding apparatus may further comprise a damper configured to permit relative movement between at least part of the pin and the structure to which the pin is mounted.

A second aspect of the present disclosure provides a wind turbine comprising:
a rotor hub;
a wind turbine blade; and
the blade guiding apparatus according to the first aspect of the present disclosure,
   wherein the pin is provided at one of the rotor hub or the wind turbine blade, and
   wherein the frame provided at the other of the rotor hub or the wind turbine blade.

In some examples, the pin may be mounted to the rotor hub and the frame may be mounted to a root end of the wind turbine blade.

In some examples, the pin may comprise a root portion, said root portion being mounted to the rotor hub, and a tip portion for locating into the hole provided at the frame.

In some examples, the root portion and the tip portion of the pin may be releasably detachable.

A third aspect of the present disclosure provides a method of securing a wind turbine blade to a rotor hub using the blade guiding apparatus according to the first aspect of the present disclosure, the method comprising:
a) providing the pin at one of either the wind turbine blade or the rotor hub;
b) providing the frame at the other of the wind turbine blade or the rotor hub;
c) locating the pin in the hole when the inflatable part is in the uninflated condition; and
d) once the pin is located in the hole, inflating the inflatable part to its inflated condition to impede relative movement between the pin and the frame.

In some examples, the blade may be secured to the rotor hub via a first set of connectors which are accessible when the blade is at a first pitch and a second set of connectors which are inaccessible when the blade is at the first pitch.

In some examples, the method may further comprise:
e) securing the wind turbine blade to the rotor hub via the first set of connectors;
f) detaching a root portion of the pin from the rotor hub whilst the tip portion remains located in the hole;
g) rotating the wind turbine blade from a first pitch to a second pitch in which the second set of connectors are accessible; and
h) securing the wind turbine blade to the rotor hub via a second set of connectors,

A fourth aspect of the present disclosure provides a rotor hub for a wind turbine blade comprising:
a pin; and
an inflatable part carried by said pin, the inflatable part being configured to, upon inflation, expand from an uninflated condition in which the inflatable part has a first volume, to an inflated condition in which the inflatable part has a second volume, said second volume being greater than the first volume.

### BRIEF DESCRIPTION OF THE DRAWINGS

Examples of the invention will now be described with reference to the accompanying drawings, in which:

FIG. 1 is a front view of a wind turbine;

FIG. 2 is a perspective view of a rotor hub of a wind turbine comprising one part of a blade guiding apparatus according to one example of the present disclosure;

FIG. 3a is a perspective view of a root end of a wind turbine blade comprising the other part of a blade guiding apparatus according to one example of the present disclosure;

FIG. 3b is a front view of the frame of the blade guiding apparatus illustrated in FIG. 3a;

FIG. 3c is a perspective view of a funnel which may be provided within one of the holes provided in the frame illustrated in FIG. 3b;

FIG. 4a is a side view of one of the pins of the blade guiding apparatus illustrated in FIG. 2;

FIG. 4b is a front view of the pin illustrated in FIG. 4a;

FIG. 4c is a front view of a pin of a blade guiding apparatus according to another example of the present disclosure;

FIGS. 5a to 5c illustrate a blade guiding apparatus according to yet another example of the present disclosure;

FIG. 6a is a perspective view of a pair of pins which form part of a blade guiding apparatus according to yet a further example of the present disclosure;

FIG. 6b is a side view of the blade guiding apparatus illustrated in FIG. 6a in which the pair of pins are mounted to a rotor hub; and

FIGS. 7a to 7e depict a method of securing a wind turbine blade to a rotor hub using a blade guiding apparatus according to an example of the present disclosure.

### DETAILED DESCRIPTION OF EMBODIMENT(S)

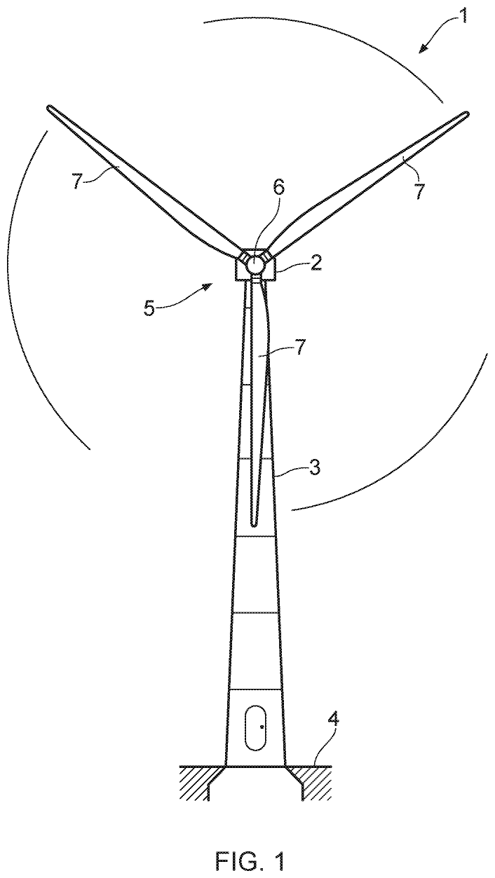

FIG. 1 shows a wind turbine 1 including a nacelle 2 supported on a tower 3 that is mounted on a foundation 4. The wind turbine 1 depicted here is an onshore wind turbine such that the foundation 4 is embedded in the ground, but the wind turbine 1 could be an offshore installation in which case the foundation 4 would be provided by a suitable marine platform, such as a monopile or jacket.

The nacelle 2 supports a rotor 5 comprising a hub 6 to which three blades 7 are attached. The blades 7 which make up the rotor 5 of the wind turbine 1 each comprise a tip end, which is located distal from the hub 6, and a root end, which is located proximal to the hub 6.

It will be noted that the wind turbine 1 is the common type of horizontal axis wind turbine (HAWT) such that the rotor 5 is mounted at the nacelle 2 to rotate about a substantially horizontal axis defined at the centre at the hub 6. As is known, the blades 7 are acted on by the wind which causes the rotor 5 to rotate about its axis thereby operating generating equipment through a gearbox (not shown) that is housed in the nacelle 2. The generating equipment is not shown in FIG. 1 since it is not central to the examples of the invention.

During installation of the wind turbine 1, the tower 3 is first installed onto the foundation 4 (or marine platform if the wind turbine 1 is an offshore installation). The tower 3 may be installed via stacking a plurality of tower sections one atop the other (as shown in FIG. 1), or alternatively the tower 3 may be provided as a single, monolithic structure. Once the tower 3 has been installed onto the foundation 4 or marine platform, the nacelle 2 is hoisted and positioned atop the tower 3. The generating equipment such as the generator, gearbox, rotor shaft etc. can then be loaded into the nacelle 2 and installed. Once installed, a portion of the rotor shaft will protrude out of the front of the nacelle 2 to which the rotor hub 6 is mounted. Finally, the installation is completed via connecting each of the wind turbine blades 7 one by one to corresponding mountings provided at the rotor hub 6.

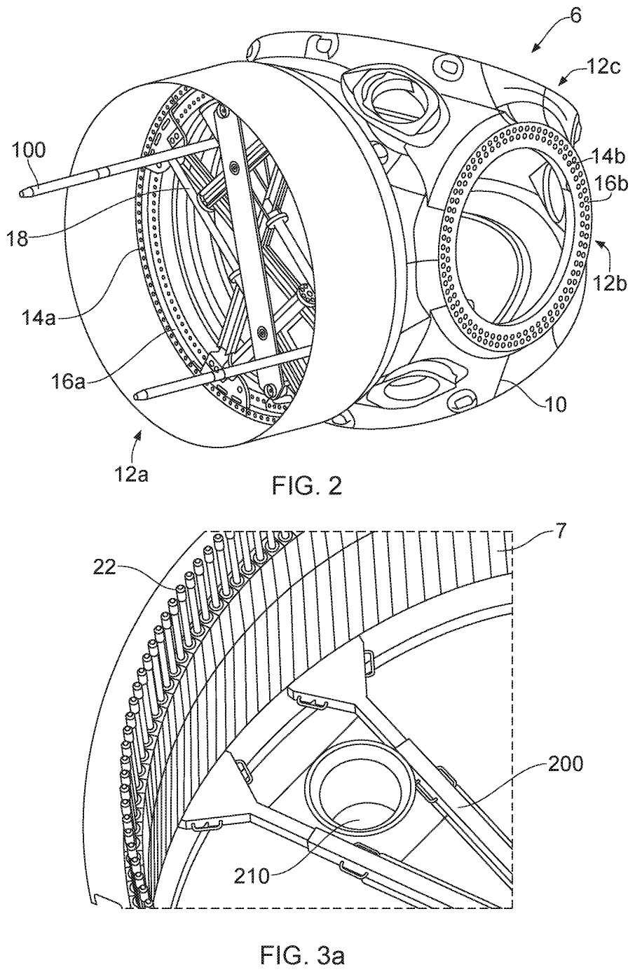

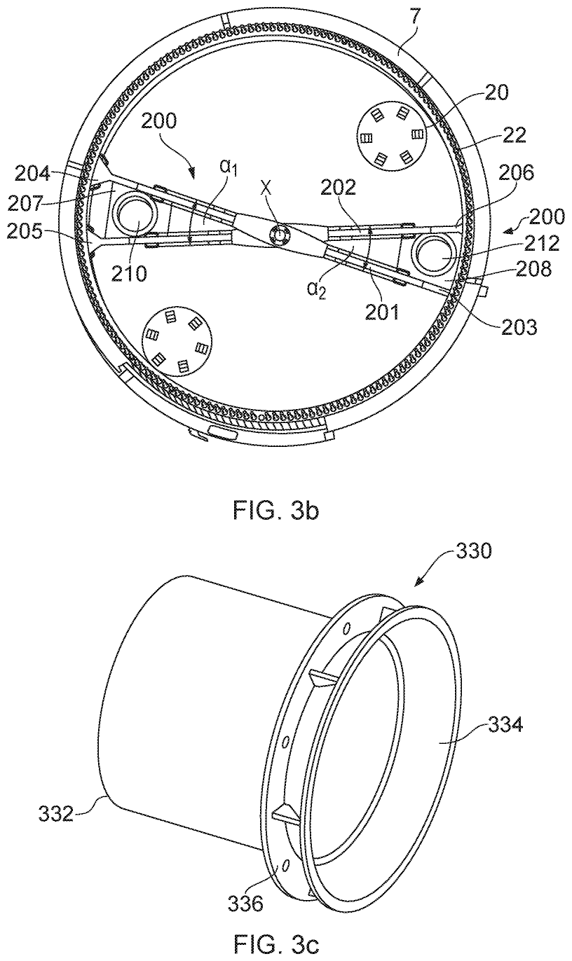

FIGS. 2 and 3 show a rotor hub 6 and the root end of a wind turbine blade 7 for connecting to a corresponding mounting provided at the rotor hub 6.

Referring firstly to FIG. 2, the rotor hub 6 has a body 10 which is roughly spheroidal in shape. In the rotor hub 6 depicted in FIG. 2, the body 10 is provided as a single cast-iron casting and hence constitutes a single unitary structure. However, in other examples, the body 10 of the rotor hub 6 may be provided in multiple sections. The body 10 of the rotor hub 6 is substantially hollow and hence a cavity is defined therein.

A plurality of mountings 12a-c are disposed about the body 10 of the rotor hub 6 to which one or more wind turbine blades 7 can be coupled. The rotor hub 6 illustrated in FIG. 2 comprises three mountings 12a-c which are disposed about the circumference of the rotor hub 6 at intervals of approximately 120 degrees. Consequently, the rotor hub 6 depicted in FIG. 2 is configured for carrying three turbine blades 7. However, in other examples, the rotor hub 6 may comprise a different number of mountings, such as 2, 4, 5, 6 etc., and hence in some examples, the rotor hub 6 may carry less than three turbine blades or more than three turbine blades.

In examples where the number of mountings is less than or greater than three, the mountings may be disposed about the circumference of the rotor hub 6 at intervals which are more or less than 120 degrees. For instance, in some examples, the plurality of mountings may be disposed about the circumference of the rotor hub 6 at intervals of 360/N degrees, wherein N is the number of mountings/turbine blades.

A rotatable bearing 16a-c (or pitch bearing) is rotatably coupled to each mounting 12a-c. In the illustrated example, the rotatable bearings 16a-c are provided as substantially ring-shaped structures and extends around an outer circumference of the mountings 12a-c. However, in other examples, other forms of bearing may be used.

In the examples illustrated in FIGS. 2 and 3, the bearings 16 are provided with a plurality of boltholes 14a-c which are disposed around a circumference of each bearing 16a-c. The plurality of boltholes 14a-c are each configured to receive corresponding connectors 22 provided at the root end of the wind turbine blade 7.

In the example illustrated in FIG. 3a, the plurality of connectors 22 are provided as a series of bolts which are configured to be received within each of the plurality of boltholes 14 where they can be secured with a suitable fastener (such as a barrel nut) thereby facilitating connection between the rotor hub 6 and the turbine blade 7. However, it shall be appreciated that other suitable connectors may instead be used.

Furthermore, in some examples, the plurality of connectors may be disposed around the circumference of the bearing 16 for insertion into boltholes 14 provided at the root end of the wind turbine blade 7.

The rotatable bearing 16 is rotatably coupled to the mounting 12 in a manner which permits axial rotation of the bearing 16, thereby allowing for pitch-wise rotation of the wind turbine blade 7 (which is mounted to the bearing 16) relative to the rotor hub 6. The pitch of each turbine blade 7 is adjusted via one or more blade pitch actuators 18 which are housed within the cavity of the rotor hub 6 at or proximal to the mountings 12a-c. In some examples, the blade pitch actuators 18 may be provided as one or more hydraulic cylinders. In other examples, different types of actuator (such as electric actuators) may be utilised.

The blade pitch actuators 18 are controlled via a pitch control system (not shown) which may alter the pitch of the turbine blades 7 coupled to the mountings 12a-c via activating the corresponding blade pitch actuators 18 so as to cause the actuators 18 to rotate the rotatable bearing 16 to which the turbine blade 7 is mounted. Typically, the pitch control system will alter the pitch of the turbine blade 7 based on various factors (such as wind speed, power demand etc.) to increase or decrease the rotational speed of the rotor 5, thereby regulating the power output of the wind turbine 1. However, in some circumstances, the pitch control system may also control the blade pitch actuators 18 to move the blades into a zero lift (or “feathered”) position when wind speeds are too high for the wind turbine 1 to safely operate. The means by which the pitch of the one or more wind turbine blades 7 can be adjusted is not central to the examples of the invention and hence shall not be described in further detail.

As set out within the Background section above, positioning the wind turbine blades 7 and rotor hub 6 so that each of the plurality of boltholes 14a-c align with their corresponding connector 22 is incredibly difficult. One of the primary reasons for this is that high winds acting on the blade 7 and tower 3 during installation will cause relative movement between the blades 7 and the rotor hub 6. This problem is further exacerbated when the wind turbine 1 is an offshore installation since tidal motions can further add to the relative movement between these components.

To address this issue, a blade guiding apparatus is provided to help account for and mitigate the issues caused by relative movement between the rotor hub 6 and the turbine blade 7 during installation.

The blade guiding apparatus is made up of a pin 100 and a corresponding frame 200 which has a hole 210 for receiving the pin 100. In the examples illustrated in FIGS. 2 and 3, the pin 100 is mounted to the body 10 of the rotor hub 6 at a position inboard of the pitch bearing 16a such that the pin 100 extends through and protrudes out of the pitch bearing 16a. Meanwhile, the frame 200 is provided at the root end of the wind turbine blade 7. However, in other examples, the opposite arrangement may be envisaged wherein the pin is mounted at the root end of the wind turbine blade 7 and wherein the frame is provided at the rotor hub 6.

The frame 200 is shown in greater detail in FIG. 3b.

In the example depicted in FIG. 3b, the frame 200 is not an integral part of the wind turbine blade 7 (and so does not form part of the structure of the wind turbine blade 7) but is instead provided as a separate reinforcement structure which is mounted to the root end of the wind turbine blade 7 post-manufacture. However, it shall be appreciated that in other examples (such as the example depicted in 5a), the frame may form an integral part of the structure of the wind turbine blade 7 or rotor hub 6.

In FIG. 3b, the frame 200 is provided as a blade jack arrangement which is made up of a pair of legs 201, 202 with each leg 201, 202 carrying a pair of opposing pistons 203, 204 and 205, 206 provided at either end of each leg 201, 202. In the illustrated example, the pair of opposing pistons are a pair of hydraulic pistons having a capacity of up to five tonnes. However, it shall be appreciated that in other examples, other types of piston may be used.

The pistons 203, 204 and 205, 206 provided at the end of each leg 201, 202 are configured to urge against the internal surface(s) of the wind turbine blade 7 thereby forming an interference fit which holds the blade jack arrangement in place. The provision of a blade jack arrangement which urges against the internal surface(s) of the wind turbine blade 7 also achieves a secondary benefit of helping to prevent blade “ovalisation” which can occur during storage.

In the example illustrated in FIG. 3b, the first 201 and second 202 legs which make up the blade jack arrangement are arranged in a cross configuration such that a pair of opposing angles α₁, α₂ are formed between the first 201 and second 202 legs. In the illustrated example, the opposing angles α₁, α₂ formed between the first 201 and second legs 202 are acute angles between 10° and 45°. However, it shall be appreciated that in other examples, the frame may have a different configuration and/or structure.

As set out above, the frame 200 comprises a hole 210 for receiving the pin 100.

In the example illustrated in FIG. 3b, the frame 200 comprises two holes 210, 212 for receiving corresponding pins provided at the rotor hub 6. However, it shall be appreciated that in other examples, the frame 200 may have a single hole or may have more than two holes, such as 3, 4, 5, 6 or 7 holes etc. in examples wherein the blade guiding apparatus has more than two pins.

In the illustrated example, the holes 210, 212 are provided in associated inserts 207, 208 which are carried on the frame 200. As shown in FIG. 3b, the first 201 and second 202 legs which make up the blade jack arrangement intersect at a point X which is located mid-way along the length of each leg 201, 202. The first insert 207 (which carries the first hole 210) is carried between the first 201 and second 202 legs on a first side of said intersection point X and the second insert 208 (which carries the second hole 212) is carried between the first 201 and second legs 202 on the second side of said intersection point X. The first 210 and second 212 holes are spaced apart by an arc having a central angle of approximately 180 degrees.

In the example illustrated in FIG. 3b, the frame 200 (and hence the legs 201, 202 and associated inserts 207, 208) are made from a metallic material such as steel. However, it shall be appreciated that in other examples, other types of material may be used.

Referring now to FIG. 3c, in the illustrated example a funnel 330 is provided within each of the holes 210, 212 to increase the “catch radius” of the respective holes thereby making it easier to locate the pin(s) 100 within the hole(s) 210, 212.

In the illustrated example, the funnel 330 has a substantially cylindrical portion 332 having a constant diameter which is designed to be received within the hole 210, 212, and a flared portion 334 which is designed to protrude out of the hole(s) 210, 212 during use. A flange 336 may be provided on an outer surface of the funnel 330 between the cylindrical portion 332 and the flared portion 334 which is configured to abut against the frame 200 when the cylindrical portion 332 has been fully inserted into its respective hole 210, 212. In some examples, the flange 336 may also be provided with one or more boltholes for securing the funnel 330 to the frame 200.

In the illustrated example, the funnel 330 is made from a reinforcing material such as steel or aluminium to help increase the durability of the frame 200 and to help prevent damage which can occur due to unwanted impacts between the pin and the frame during installation as the pin is located in the hole. However, it shall be appreciated that any other suitable material may also be used.

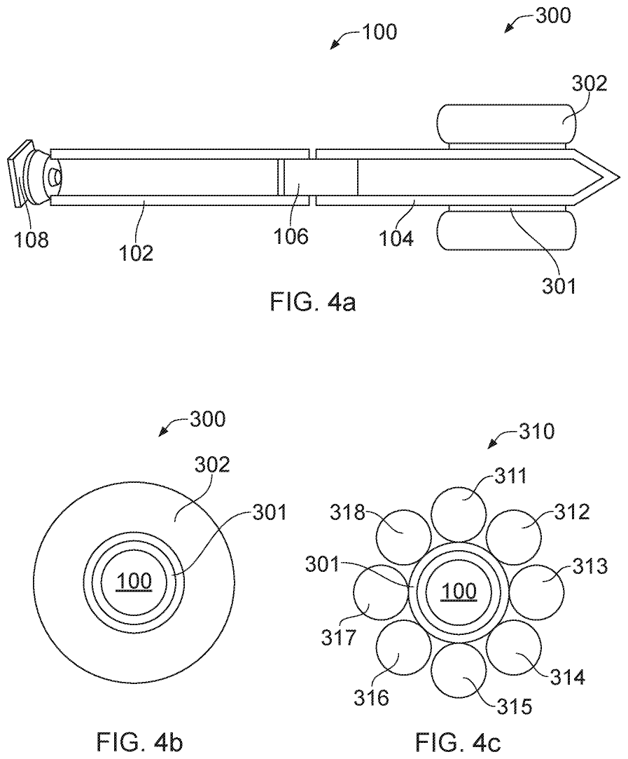

Considering now the pin 100, the pin 100 is shown in greater detail in FIG. 4a an 4b.

The pin 100 is made up of a root portion 102 for mounting the pin 100 to the turbine blade 7 or the rotor hub 6 and a tip portion 104 for locating within the hole 210 provided in the frame 200.

In the example depicted in FIGS. 4a and 4b, the pin 100 is provided in the form of an elongate projection having a substantially circular cross-sectional shape. The root portion 102 of the pin 100 is substantially cylindrical (and therefore has a constant diameter) whilst the tip portion 104 of the pin 100 tapers to a pointed tip which is provided at the distal end of the pin 100. However, in other examples, the pin 100 may have a uniform cross-sectional shape along its entire length which may or may not be circular. Notably, in some alternative examples, the pin may be provided by a projection having a square, rectangular or elliptical cross-sectional shape.

In the example depicted in FIG. 4a, the root portion 102 and the tip portion 104 are provided as separate parts with a releasable connector 106 provided therebetween. As such, the root portion 102 and the tip portion 104 are releasably detachable. The releasable connector 106 may be provided in the form of a screw thread, a ferrule, a quick-release clasp, or any other suitable connector type. In other examples, the connector 106 may be omitted and the root portion 102 and tip portion 104 may be provided as parts of a single, monolithic structure.

The pin 100 may also comprise a damper 108 configured to permit relative movement between at least part of the pin 100 and the structure (e.g., the rotor hub 6 or turbine blade 7) to which the pin 100 is mounted. In the example illustrated in FIG. 4a, the damper 108 is provided at the root end of the pin 100 such that the pin 100 is mounted to the rotor hub 6 via the damper 108. As such, the damper 108 illustrated in FIG. 4a allows the entirety of the pin 100 to move relative to the part to which it is mounted. In other examples, the damper 108 may be provided part way along the root portion 102, between the root portion 102 and the tip portion 104 or part way along the tip portion 104 such that only some parts of the pin 100 are able to move relative to the structure to which the pin is mounted.

The provision of a damper 108 allows the pin to oscillate along with the relative movement of the blade or rotor hub to which the pin 100 is mounted. The damper 108 can also help to absorb and dissipate bending stresses which may otherwise damage or deform the pin 100 during use.

In the illustrated examples, the pin 100 is made from a fibre-reinforced composite material such as a carbon or glass fibre reinforced composite material. Advantageously, the use of fibre-reinforced materials helps to provide the pin(s) with the desired levels of stiffness to help prevent them from bending during use whilst also keeping the structure lightweight, thereby making it easier to hoist and/or secure the pins to the rotor hub or wind turbine blade. However, it shall be appreciated that in other examples, the pin(s) may be manufactured from other lightweight materials such as aluminium or high-strength polymeric materials.

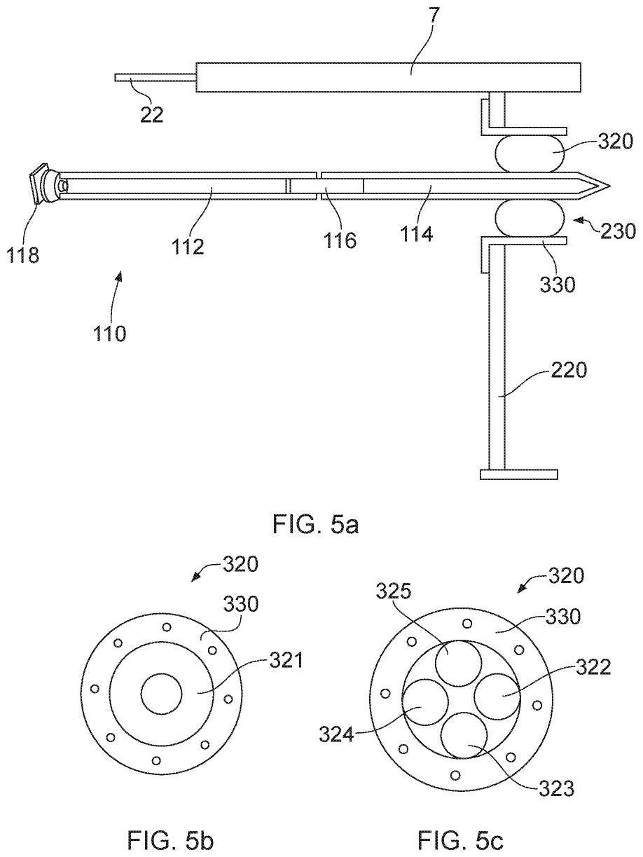

In addition to the pin 100 and frame 200 described above, the blade guiding apparatus also includes an inflatable part 300 as shown in FIGS. 4 and 5 which is configured to, upon inflation, form an interference fit between the pin 100 and the frame 200 within which the pin 100 is received,

In the examples depicted in FIGS. 4a to 4c, the inflatable part 300 is carried by the pin 100. However, as shall be described in greater detail at a later part of this application with reference to FIGS. 5a to 5c, in some examples the inflatable part 300 may be carried by the frame 200.

In the example illustrated in FIGS. 4a and 4b, the inflatable part 300 is provided as a single torus-shaped (or doughnut-shaped) cushion 302 which is carried by the tip portion 104 and which extends around a circumference of the pin 100. The tip portion 106 of the pin 100 is inserted into the “hole” provided at the centre of the cushion 302. In some examples, such as that which is illustrated in FIG. 4a, the cushion 302 may be slidably mounted to the pin 100. In the example depicted in FIG. 4a, the cushion 302 is mounted to the tip portion 106 via a sliding tube 301 comprising PTFE or another low friction material such that the pin 100 is able to slide through the cushion 302 as the pin 100 becomes located within the hole 210 or funnel 330 provided at the frame 200. In such examples, since the distance between interference fit (formed between the cushion 302 and the hole 210 or funnel 330) and the component to which the pin 100 is mounted (e.g., the rotor hub 6 or wind turbine blade 7) will steadily reduce as the pin is inserted into the hole 210 or funnel 330, any relative movements between the rotor hub 6 and the wind turbine blade 7 will consequently become less pronounced. As such, this feature helps to keep the rotor hub 6 and wind turbine blade 7 in alignment.

In other examples, other forms of slidable mounting may be used or, alternatively, the cushion 302 may be fixed to the pin 100 in a manner which does not permit lengthwise movement of the cushion 302 along the pin 100. In such examples, in order to help reduce relative movement between the wind turbine blade 7 and the rotor hub 6 during insertion, the cushion 302 may extend along the full length of the pin 100.

An inflatable part 310 according to a different example of the present disclosure is depicted in FIG. 4c.

As with the inflatable part 300 illustrated in FIGS. 4a and 4b, the inflatable part 310 is carried by the pin 100 and extends around a circumference of the pin 100. However, whereas the inflatable part 300 comprises a single torus-shaped cushion 302, the inflatable part 310 comprises a plurality of inflatable fender-like (or sausage-shaped) cushions 311-318 which are disposed at various points around the circumference of the pin 100.

In the example illustrated in FIG. 4c, the inflatable part 310 is made up of eight cushions 311-318 which are disposed at intervals of approximately 45 degrees about the circumference of the tip portion 106. In other examples, the inflatable part may feature less than eight cushions, such as 2, 3, 4, 5, 6 or 7 cushions, or may feature more than eight cushions, such as 9, 10, 11, 12 etc. cushions. In examples where the number of cushions is less than or greater than eight, the cushions may be disposed about the circumference of the pin 100 at intervals which are more or less than 45 degrees. In some examples, the cushions may be regularly disposed about the circumference of the pin 100 at intervals of 360/N degrees wherein N is the number of cushions. In other examples, the cushions may be irregularly spaced.

Referring now to FIG. 5a, as set out above, in alternative examples, the inflatable part may be carried by the frame.

The blade guiding apparatus described in FIG. 5a has many features in common with that which is described in FIG. 4a and so, for the sake of conciseness, only the differences shall be described herein. Corresponding features have been denoted with like reference numerals.

As with the blade guiding apparatus depicted in FIG. 4a, the pin 110 of the blade guiding apparatus disclosed in FIG. 5a has a root portion 112 (for mounting the pin 110 to the rotor hub 6 or wind turbine blade 7) and a tip portion 114 (for locating within a hole 230 provided in the frame 220) with a releasable connector 116 provided between the root 112 and tip 114 portions. A damper 118 is also provided at the root end of the pin 100 to allow the pin 110 to move relative to the structure to which it is mounted (in this case the rotor hub 6).

A frame 220 is also provided at a root end of a wind turbine blade 7 which comprises a hole 230 within which the tip portion 114 of the pin 110 can be located.

However, unlike the frame 200 depicted in FIGS. 3a and 3b, the frame 220 depicted in the example shown in FIG. 5a form an integral part of the structure of the turbine blade 7 and so is not provided on a separate component. However, it shall be appreciated that in other examples, the frame may be provided as a separate component which is mounted to the turbine blade post-manufacture (such as the frame depicted in FIGS. 3a and 3b).

Furthermore, unlike the blade guiding apparatus illustrated in FIG. 4a, the inflatable part 320 is provided in the hole 230, and so is carried by the frame 220 rather than being carried on the pin 110.

In the example illustrated in FIG. 5a, a reinforcing funnel 330 having a cylindrical portion and a flared portion is provided within the hole 230. The funnel 330 illustrated in FIG. 5a is substantially the same as that which is described in FIG. 3c and so shall not be described in any greater detail.

Referring now to FIG. 5b, in the illustrated example, the inflatable part 320 is provided as a single torus-shaped (or doughnut-shaped) cushion 321 which extends around a circumference of the hole 230. In the illustrated example, the inflatable part is attached to, and extends around a circumference of, the cylindrical portion of the funnel 330. However, it shall be appreciated that in another example (in which the funnel is omitted), the inflatable part 320 may be attached directly to the frame 220.

Furthermore, whilst in the example depicted in FIG. 5b the inflatable part 320 is provided as a single cushion 321, in other examples the inflatable part 320 may have a different configuration. An example of this is depicted in FIG. 5c in which the inflatable part 320 comprises a plurality of inflatable fender-like (or sausage-shaped) cushions 322-325 which are disposed at various points around the circumference of the hole 230.

In the example illustrated in FIG. 5c, the inflatable part 320 is made up of four cushions 322-325 which are disposed at intervals of approximately 90 degrees about the circumference of the hole 230. In other examples, the inflatable part may feature less than four cushions, such as 2 or 3 cushions, or may feature more than four cushions, such as 5, 6, 7, 8, 9, 10, 11, 12 etc. cushions. In examples where the number of cushions is less than or greater than four, the cushions may be disposed about the circumference of the hole 230 at intervals which are more or less than 90 degrees. In some examples, the cushions may be regularly disposed about the circumference of the hole 230 at intervals of 360/N degrees wherein N is the number of cushions. In other examples, the cushions may be irregularly spaced.

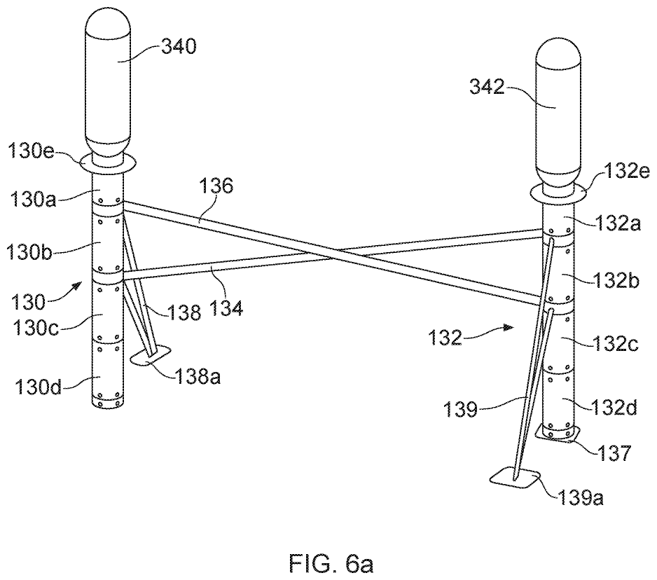

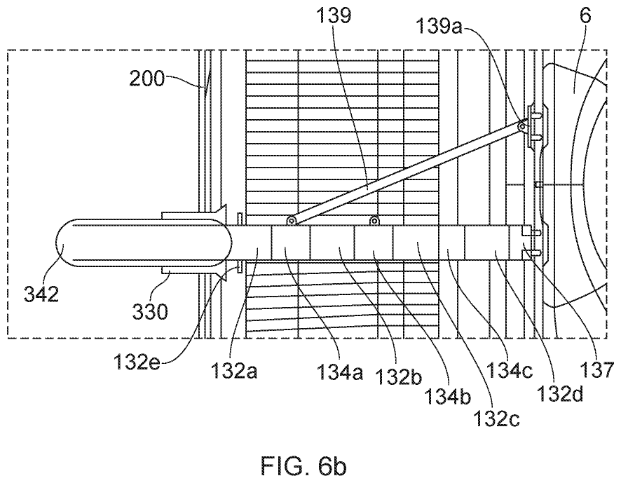

A blade guiding apparatus according to yet a further example is illustrated in FIGS. 6a and 6b.

The blade guiding apparatus illustrated in FIGS. 6a and 6b is made up of two pins, a first pin 130 and a second pin 132, which are each configured to be received within a corresponding hole provided in an associated frame.

The first 130 and second pins 132 are made up of a plurality of releasably connectable sections. In the example illustrated in FIGS. 6a and 6b, the first 130 and second 132 pins are made up of four sections 130a-d and 132a-d with a releasable coupling 134a-c being provided between each section. The releasable couplings 134a-c may be provided in the form of a thread, a ferrule, a quick-release clasp or any other suitable type. It shall also be appreciated that in other examples, the first 130 and second 132 pins may be made up of less than four sections, such as 2 or 3 sections, or may be made up of more than four sections, such as 5, 6, 7, 8 or 9 etc. sections.

The sections which make up the first 130 and second 132 pins are each made of a lightweight material such that the weight of each section is less than 20 kg. This allows the pins to be easily transported into the nacelle 2 and assembled prior to being attached to the rotor hub 6. Typically, the first 130 and second 132 pins are made from a fibre-reinforced composite material, such as a carbon or glass fibre reinforced composite. However, in other examples, other lightweight materials such as aluminium or high-strength polymeric materials may be used.

The first 130 and second pins 132 are provided as a pair of elongate, cylindrical projections having a tip portion for locating in a corresponding hole provided in the frame and a root portion for mounting the pins to a rotor hub 6 or a wind turbine blade 7.

In the example illustrated in FIGS. 6a and 6b, the tip portions of the first 130 and second pins 132 are provided by the first sections 130a, 132a only and the root portions of the first 130 and second 132 pins are provided by the remaining sections 130b-d, 132b-d.

The tip portions 130a, 132a of the first 130 and second 132 pins each carry a respective inflatable part 340, 342. In the illustrated example, the inflatable parts 340, 342 are provided as a single fender-like cushion which is received on the end of each pin 130, 132 such that the tip portions 130a, 132a of the pins 130, 132 terminate within the volume of the inflatable parts 340, 342. In other words, the tip portions of the pins 130, 132 do not protrude beyond the volume of the inflatable parts 340, 342. However, it shall be appreciated that in other examples, other suitable types of inflatable part (such as those disclosed in FIG. 4a-c and 5a-c) may instead be used.

The tip portions 130a, 132a also feature a flange 130e, 132e which extends circumferentially around the pin 130, 132 beneath the inflatable part 340, 342 for abutting against a surface of the frame when the tip portion 130a, 132a is fully received in the hole(s) (not shown) provided in the frame.

In the illustrated example, an interconnection is also provided between the first 130 and second pins 132 to help improve the stiffness and rigidity of the blade guiding apparatus. In the illustrated example, the interconnection is provided via a pair of cross-members 134, 136 which extend between the first 130 and second pins 132. However, it shall be appreciated that in other examples, different types of interconnections may be used. Furthermore, in some examples, the cross-members may be omitted.

Referring now to FIG. 6B, in the illustrated example the second 132 pin is mounted to the rotor hub 6 via a respective coupling 137. In the example depicted in FIG. 6B, the coupling 137 is secured to section 132d which makes up part of the root portion of the pin 132. A corresponding coupling is also provided for the first pin 130 which is secured to the rotor hub 6 in the same manner (although this is not shown in FIGS. 6A and 6B).

The first 130 and second 132 pins are also provided with an associated strut 138, 139 which provides a further point of connection between the pins 130,132 and the rotor hub 6. This helps to further improve the stiffness of each pin 130, 132. In the example illustrated in FIG. 6B, the strut 139 has a first end which is connected to the coupling 134a provided between the first 132a and second 132b sections of the pin 132 and a second end which is coupled to the rotor hub 6 via a respective mounting 139a. However, it shall be appreciated that in other examples, the strut 139 may be connected at different points along the pin 132 or in some examples, may be omitted altogether.

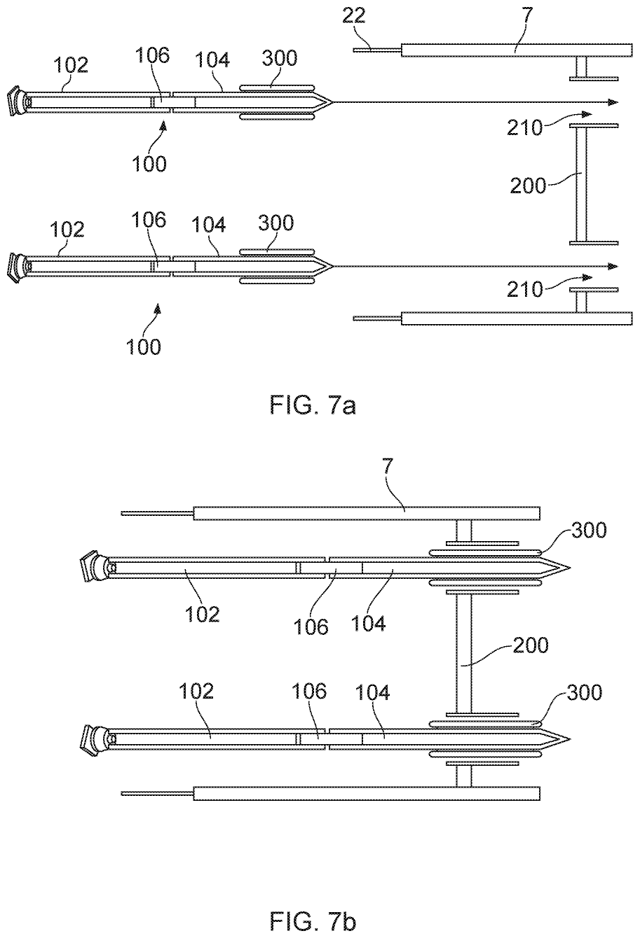

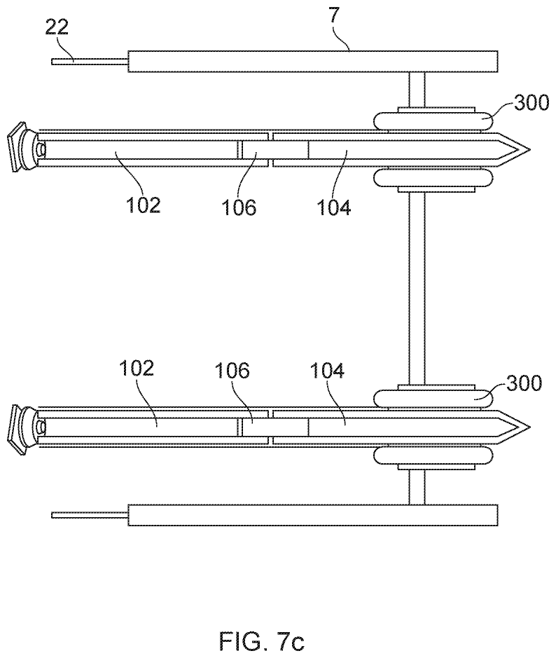

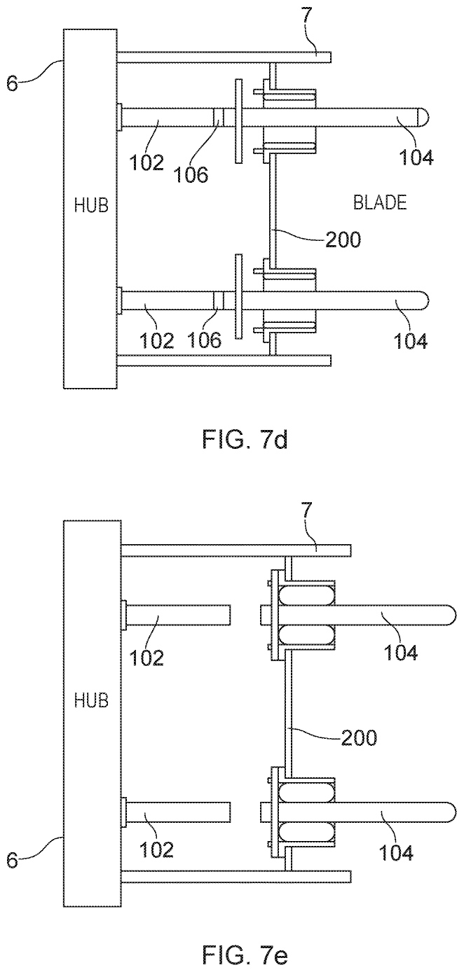

A method of securing a wind turbine blade 7 to a rotor hub 6 using the blade guiding apparatus according to an example of the present disclosure shall now be described with reference to FIGS. 7a to 7e.

It shall be appreciated that whilst the method is described in FIGS. 7a to 7e with reference to a blade guiding apparatus similar to that which is depicted in FIGS. 4a and 4b, the same method is also applicable for other blade guiding apparatuses such as those depicted in FIGS. 4c, 5a-c and 6a-b.

The first step of the method involves providing a pin 100 at one of either a rotor hub 6 or a wind turbine blade 7 and providing a frame 200 at the other of a rotor hub 6 or a wind turbine blade 7.

In the illustrated example, a pair of pins 100 are mounted to a rotor hub 6 which are designed to be received within a pair of corresponding holes 210 provided in a frame 200 which forms an integral part of the wind turbine blade 7. In other examples, the pin or pins may be mounted to the turbine blade 7 and may be received within a hole or holes provided at the rotor hub 6. Furthermore, whilst the frame 200 depicted in FIG. 7a forms an integral part of the wind turbine blade 7, in other examples (such as the one depicted in FIGS. 3a and 3b), the frame 200 may be provided as a separate component which is mounted to the wind turbine blade 7 post-manufacture.

In a second step of the method, the pin 100 is located in the hole 210 provided in the frame 200.

In the illustrated example, the blade guiding apparatus has a pair of pins 100 and so during the second step, both pins 100 are located into the corresponding holes 210 provided on the frame 200. During the second step, the inflatable part 300 is in an uninflated condition. When the inflatable part 300 is in its uninflated condition, the inflatable part 300 contacts only one of the pin 100 or the frame 200 (in this instance only the pin 100). As such, when the inflatable part 300 is in an uninflated condition, relative movement between the pin 100 and the frame 200 is not impeded and the therefore the pin 100 can be easily located within the frame 200 even when being subjected to relative movements between the frame 200 and pin 100 due to high winds or tidal motions acting on the wind turbine blade 7 and/or the rotor hub 6.

Once at least part of the pin 100 is in the hole 210, the inflatable part 300 is inflated thereby causing it to expand from its uninflated condition, wherein the inflatable part 300 has a first volume, to its inflated condition, wherein the inflatable part 300 has a second volume, said second volume being greater than the first volume. The expansion of the inflatable part 300 causes it to contact both the pin 100 and the frame 200 thereby creating an interference fit between the pin 100 and frame 200 and hence impeding any relative movement between the pin 100 and the frame 200.

In the illustrated embodiment, the inflatable part 300 is carried by the pin 100 and so, upon expansion from its uninflated condition to its inflated condition, the inflatable part 300 comes into contact with the frame 200. However, in other examples in which the inflatable part 300 is carried by the frame 200, the inflatable part 300 may, upon expansion, come into contact with the pin 100.

In most examples, the inflatable part 300 is inflated via pumping gas (such as air) into the inflatable part via a pumping arrangement (not shown) which is provided in fluid communication with the inflatable part 300. In some examples, the pumping arrangement may be provided as a spiral air hose which is coupled to a pump or air tank which is housed inside the pin 100 thereby allowing for fast inflation or deflation of the inflatable part 300. In other examples, the pumping arrangement may instead be located remotely, for example at the frame 200 or within the turbine blade 7 or rotor hub 6 and be fluidly connected to the inflatable part using one or more hoses or pipes. It shall also be appreciated that in other examples, other gases or fluids such a water, hydrogen, helium etc. may be used to inflate the inflatable part from its uninflated condition to its inflated condition.

Once the inflatable part 300 has reached is inflated condition such that an interference fit is formed between the pin 100 and the frame 200, the blade guiding apparatus provides a secure connection between the wind turbine blade 7 and the rotor hub 6 which prevents relative movement between the blade 7 and the hub 6. As such, when high winds or tidal motions act on the wind turbine 1, the blade 7 and the hub 6 will move in a synchronised manner. This makes it much easier for operators to align the connectors 22 provided at the root end of the turbine blade 7 with the corresponding boltholes 14a-c provided at the rotor hub 6 (or vice versa) and hence the connection of the wind turbine 7 to the rotor hub 6 can be more easily facilitated.

It shall also be appreciated that in some examples, it is not always possible to access all of the connectors 22 required to securely connect the wind turbine blade 7 to the rotor hub 6. As such, in some examples, the wind turbine blade 7 may need to be rotated (or pitched) about its longitudinal axis to allow an operator to access and secure all the connectors 22.

As such, an exemplary method of pitching and securing a wind turbine blade 7 shall now be described with reference to FIGS. 7d and 7e.

Before the wind turbine blade 7 can be pitched, it is first secured to the rotor hub 6 via a first set of connectors (not shown) which are accessible to an operator when the wind turbine 7 is orientated at a first pitch. Once the first set of connectors have been secured, it is desirable to rotate the wind turbine blade from the first pitch to a second pitch so as to allow an operator to access and secure a second set of connectors which are inaccessible to the operator when the blade 7 is orientated in the first pitch. This is done via activating one or more of the blade pitch actuators 18 (e.g., via the pitch control system) to cause the rotatable bearing 16 (and hence the wind turbine blade 7 mounted thereto) to rotate in a pitch-wise direction about its longitudinal axis from the first pitch to the second pitch.

However, it is not possible to activate the blade pitch actuators 18 when the pin or pins 100 of the blade guiding apparatus are mounted to the rotor hub 6 since the pin or pins 100 would interfere with the blade pitch actuators 18. As such, before the blade pitch actuators 18 are activated, the root portions of the pin or pins 100 must be detached from the rotor hub 6. In some examples in which the pin or pins 100 are provided as a plurality of releasably detachable sections, the tip portion 104 of the pin 100 may be detached from the root portion 102 of the pin 100 whilst the tip portion 102 remains in-situ within the hole 210 (and prior to the root portion 102 of the pin 100 being detached from the rotor hub 6). Advantageously, this helps to reduce construction times since the turbine blade can be pitched to allow access to some of the (previously inaccessible) connectors without having to disconnect and dissemble the entire pin assembly.

Once the root portion 102 of the pin 100 has been detached from the hub 6, the wind turbine blade 7 is rotated from the first pitch to the second pitch, which allows the operator to access the second set of connectors (not shown). The second set of connectors can then be secured and fastened thereby completing the installation of the blade 7 onto the rotor hub 6. This process is then repeated for each of the blades 7 until each blade is securely connected to the rotor hub 6.

Although the invention has been described above with reference to one or more preferred examples, it will be appreciated that various changes or modifications may be made without departing from the scope of the invention as defined in the appended claims.

1. A blade guiding apparatus for facilitating connection between a wind turbine blade and a rotor hub, the blade guiding apparatus comprising:
a pin;
a frame comprising a hole for receiving the pin; and
an inflatable part configured to, upon inflation, expand from an uninflated condition in which relative movement between the pin and the frame is not impeded by the inflatable part, to an inflated condition in which said relative movement is impeded by the inflatable part.

2. The blade guiding apparatus according to claim 1, wherein the inflatable part is configured to, upon inflation, form an interference fit between the pin and the frame.

3. The blade guiding apparatus according to claim 1, wherein the inflatable part contacts only one of the pin or the frame when it is in its uninflated condition, and wherein the inflatable part contacts both the pin and the frame when it is in its inflated condition.

4. The blade guiding apparatus according claim 3, wherein the inflatable part comes into contact with the pin or the frame as it expands to its inflated condition.

5. The blade guiding apparatus according to claim 1, wherein the inflatable part is carried by the pin.

6. The blade guiding apparatus according to claim 1, further comprising a pumping arrangement in fluid communication with the inflatable part for actuating the inflatable part between the uninflated and inflated conditions, and preferably wherein the pumping arrangement is housed inside the pin.

7. The blade guiding apparatus according to claim 1, wherein the inflatable part is carried by the frame, and preferably wherein the inflatable part is provided in the hole.

8. The blade guiding apparatus according to claim 1, preceding claim, wherein the inflatable part extends around a circumference of the pin or wherein the inflatable part extends around a circumference of the hole.

9. The blade guiding apparatus according to claim 1, preceding claim, wherein the inflatable part is substantially torus-shaped or wherein the inflatable part comprises a plurality of inflatable cushions.

10. The blade guiding apparatus according to claim 1, wherein the blade guiding apparatus comprises a first pin and a second pin, and wherein the apparatus further comprises an interconnection provided between the first pin and the second pin.

11. The blade guiding apparatus according to claim 1, wherein the pin comprises a fibre-reinforced composite material.

12. The blade guiding apparatus according to claim 1, further comprising a funnel provided in the hole.

13. The blade guiding apparatus according to claim 1, preceding claim, wherein the frame comprises at least one piston, for urging against a surface of a wind turbine blade.

14. The blade guiding apparatus according to claim 1, wherein the pin is formed from a plurality of releasably connectable sections, and wherein the weight of each section is less than 20 kg.

15. The blade guiding apparatus according to claim 1, wherein the apparatus further comprises a damper configured to permit relative movement between at least part of the pin and the structure to which the pin is mounted.

16. A wind turbine comprising:
a rotor hub;
a wind turbine blade; and
the blade guiding apparatus according to claim 1, wherein the pin is provided at one of the rotor hub or the wind turbine blade, and wherein the frame provided at the other of the rotor hub or the wind turbine blade.

17. The wind turbine according to claim 16, wherein the pin is mounted to the rotor hub and wherein the frame is mounted to a root end of the wind turbine blade.

18. The wind turbine according to claim 17, wherein the pin comprises a root portion, said root portion being mounted to the rotor hub, and a tip portion for locating into the hole provided at the frame, and wherein the root portion and the tip portion of the pin are releasably detachable.

19. A method of securing a wind turbine blade to a rotor hub using the blade guiding apparatus according to claim 1, the method comprising:
a) providing the pin at one of either the wind turbine blade or the rotor hub;
b) providing the frame at the other of the wind turbine blade or the rotor hub;
c) locating the pin in the hole when the inflatable part is in the uninflated condition; and
d) once the pin is located in the hole, inflating the inflatable part to its inflated condition to impede relative movement between the pin and the frame.

20. The method according to claim 19, wherein the pin comprises a tip portion and a root portion, wherein the blade is secured to the rotor hub via a first set of connectors which are accessible when the blade is at a first pitch and a second set of connectors which are inaccessible when the blade is at the first pitch, and wherein the method comprises:
e) securing the wind turbine blade to the rotor hub via the first set of connectors;
f) detaching the tip portion of the pin from the root portion of the pin;
g) detaching the root portion of the pin from the rotor hub whilst the tip portion of the pin remains located in the hole;
h) rotating the wind turbine blade from a first pitch to a second pitch in which the second set of connectors are accessible; and
i) securing the wind turbine blade to the rotor hub via the second set of connectors.
